(19) United States
(12) Patent Application Publication
(10) Pub. No.: US 2015/0074962 A1
(43) Pub. Date: Mar. 19, 2015

(54) LOAD BEARING CONTAINER MADE FROM REINFORCED WRAP

(71) Applicant: Mohammad R. Ehsani, Tucson, AZ (US)

(72) Inventor: Mohammad R. Ehsani, Tucson, AZ (US)

(21) Appl. No.: 14/029,311

(22) Filed: Sep. 17, 2013

(51) Int. Cl. A61G 17/007; B65D 1/42; B29C 51/10

(52) U.S. Cl. CPC A61G 17/007; B29C 51/10; B65D 1/42
USPC 27/7; 264/299; 264/552; 264/494; 220/200

(57) ABSTRACT

A method and an article of manufacture are disclosed for making a load bearing structural container with a reinforced wrap, substantially without using additional structural reinforcements. In various embodiments, a fiber reinforced polymer sheet may be used as the reinforced wrap to make the reinforced wrap container having detailed patterns and complex shapes embedded therein using a molding technique. Once the wrap is set and cured, the container holds its shape permanently. The container may include burial caskets and coffins, various shaped boxes, and cases for musical instrument, jewelry technical or medical equipment, guns, camera equipment, and the like. The Container may also be used as shipping packaging for the same types of equipment enumerated above.

### CROSS-REFERENCE(S) TO RELATED APPLICATION(S)

This non-provisional application is related to U.S. patent application Ser. No. 13/488,359 filed on Jun. 4, 2012, the disclosure of which is hereby expressly incorporated by reference in its entirety.

### TECHNICAL FIELD

This application relates generally to containers. More specifically, this application relates to a method and apparatus for making a strong container from a reinforced wrap.

### BRIEF DESCRIPTION OF THE DRAWINGS

The drawings, when considered in connection with the following description, are presented for the purpose of facilitating an understanding of the subject matter sought to be protected.

FIGS. 1A and 1B show example caskets suitable to be manufactured with reinforced wrap;

FIGS. 2A and 2B show example structures of reinforced wraps suitable for making caskets shown in FIGS. 1A and 1B;

FIG. 3A shows an example arrangement usable to manufacture a casket main body from reinforced wrap; and

FIG. 3B shows an example arrangement usable to manufacture a casket cover from reinforced wrap.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while the following description references caskets for burials, it will be appreciated that the disclosure may include other types of containers, such as plain boxes, musical instrument cases, jewelry boxes, technical or medical equipment cases, gun cases, camera equipment cases, and the like, and shipping packaging for the same types of equipment.

Briefly described, a method and a system are disclosed for making a light-weight load bearing structural container with a reinforced wrap, substantially without using additional structural reinforcements. In various embodiments, a fiber reinforced polymer sheet may be used as the reinforced wrap to make the reinforced wrap container having detailed patterns and complex shapes embedded therein using an example molding technique. Once the wrap is set and cured, the container holds its shape permanently. The container may include burial caskets and coffins, various shaped boxes, and cases for musical instrument, jewelry boxes, technical or medical equipment, guns, camera equipment, and the like. The Container may also be used as shipping packaging for the same types of equipment enumerated above. In various embodiments, the reinforced wrap container may be mass produced for the same application, for example, as a guitar case, while in other embodiments, the container may be custom made in limited numbers for each application. The containers made by the disclosed materials and methods are less expensive, lighter, faster to produce, and/or stronger than many other presently existing materials and techniques such as wood, metal, and Synthetic containers.

Caskets or coffins used to bury bodies after death may cost thousands of dollars due to material and construction costs. This cost can be a financial burden on families taking care of the funeral arrangements of a deceased member. Use of natural material for the construction of caskets, such as hard wood, places stress on natural resources and forests. Alternative synthetic materials that can be used to construct a casket may present a cost-effective and high quality choice for many people.

Synthetic material may be used for various packaging containers also. In today's market place, products are manufactured where it is the most efficient in terms of cost, expertise, and infrastructure, among other factors. After manufacturing, these products are shipped to various places in the country or the world. Products require good quality shipping packaging or containers to avoid damage during transportation. Many products have odd or irregular shapes and may need to have containers with corresponding shapes to provide physical support for various product components protruding outwards or receding inwards. At the same time, the shipping packages need to be cost effective, otherwise the purpose of manufacturing in remote locations to save on costs will be defeated.

Many types of packages, containers, and cases need to be structurally strong while enclosing their contents that have an irregular shape. For example, musical instruments are generally delicate and have odd shapes. Cases for the protection and transportation of such instruments are often constructed at great costs, sometimes rivaling the cost of the instrument they are to protect. Many other equipment, such as camera equipment, industrial instruments, artistic artifacts such as statues, vases, and framed paintings, and generally any delicate object needs the protection of good packaging for storage and/or transportation.

Accordingly, an alternative synthetic case for various containers, cases, and packages which is produced in a cost effective manner and can protect its contents with high quality is desirable.

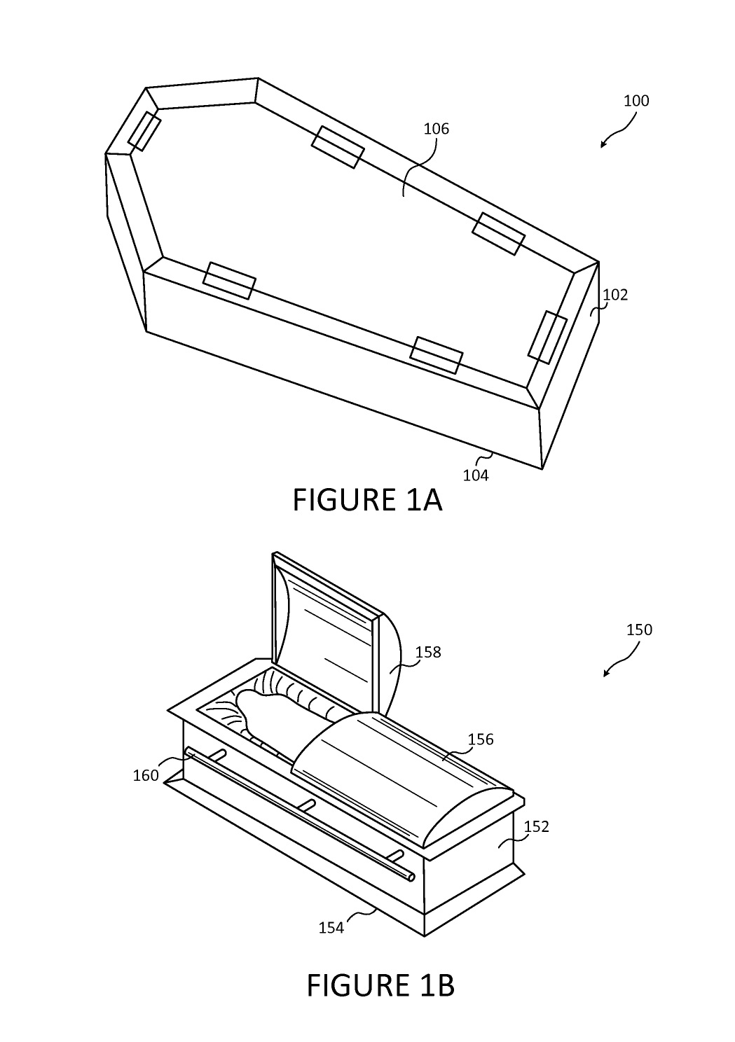

FIGS. 1A and 1B show example caskets suitable to be manufactured with reinforced wrap. With reference to FIG. 1A, in various embodiments, casket 100 generally includes body 102, lid 106, and bottom surface 104. This is one of the simplest casket configurations, generally made of wood planks or boards.

Now with reference to FIG. 1B, in various embodiments, display casket 150 includes body 152, split level lid having a lower section 156 and an upper section 158 used to display the upper body and face of the deceased for ceremonial purposes prior to burial. Handle 160 is used to carry the casket. Bottom surface 154 generally carries the most weight and is the structural backbone of the casket. In some embodiments, the inside of the casket is lined with formed display padding made of silk, velvet, or other fine material.

In various embodiments, caskets may have various embellishments such as wood working, carvings, crowns, protrusions of various kinds for various purposes, and the like. Such embellishments add to the cost of manufacturing high quality caskets.

Caskets in general have irregular shapes when viewed in their totality and are constructed by attaching and integrating discrete components together. For example, the bottom surface may be made of a slab of material such as a wooden board while the sidewalls are made of separate boards and then integrated with the bottom surface. Similarly the lids/doors are made separately and then attached to the body.

In various embodiments, a casket may be constructed from a reinforced structural material formed into a one-piece or monolithic shell for the main body of the casket having substantially any irregular geometric shape made by the use of various molding techniques. A number of molding techniques may be used to form the one-piece shell. Various shapes, curves, corners, trims, patterns, and the like may be embedded or created in the layers of the reinforced material to be visible externally in the finished product.

Various molding techniques may be used to construct the monolithic shell of the casket as a single technique or in conjunction with other techniques and molding methods. The molding techniques that may be used for this purpose include blow molding, which forms materials under pressure from inside out; lamination, which forms a three-dimensional object from layers of materials; matrix molding, which is used to form complex shapes utilizing rigid molds; Compression molding, in which material is placed in an open mold cavity and then pressure is applied to force the material into contact with all mold areas to take on the shape of the forming mold; and vacuum molding, which uses suction to form a material against a rigid forming mold. More specifically, the typical process for vacuum molding includes placing all the fabric and resin on a hard surface, draping a plastic sheet over the assembly, sealing the edges of the plastic sheet air tight, and then sucking the air out of the assembly. This forces the plastic cover to collapse and the vacuum generated forces to cause the resin to fully penetrate the fabric and the reinforcement. In various embodiments, a combination of the above molding methods may be used for forming different parts of the casket or during different stages of its manufacturing.

In some embodiments, the container or casket is created as a single formed piece with an attached flap or cap, which remains open to allow access to the inside of the casket to place the contents inside, after which the flap is closed and may be sealed. In some other embodiments, the casket is created by assembling, attaching, or otherwise integrating multiple components manufactured separately. For example, the main body of the casket may be made separately in a forming mold, the lid or door may be made in one or several sections independently of the main body, and then attached together to make the whole casket.

In some embodiments, the handle for carrying the casket may be a separate piece attached to the body of the casket, while in other embodiments, the handles may be made in the form of integrated handle cavities deployed around the main body of the casket of sufficient size to receive a human hand for lifting and carrying the casket. In still other embodiments the integrated handle may be in the form of continuous deep cavity, rim, or edge around the casket's body to allow easy lifting and handling of the casket.

In various embodiments, the casket or container may be made using a sufficient number of layers of a reinforced wrap to be structurally capable of holding its shape and integrity under the load of its contents. In other various embodiments, the casket may be made from fewer layers of the reinforced wrap and be further reinforced by metallic or synthetic reinforcement bars or members to further reinforce the structure of the casket. For example, skeletal reinforcement members may be deployed at the bottom surface of the casket and around the edges or bends in the casket to help support the weight and prevent excessive deformation of the casket under static and dynamic loading during transportation.

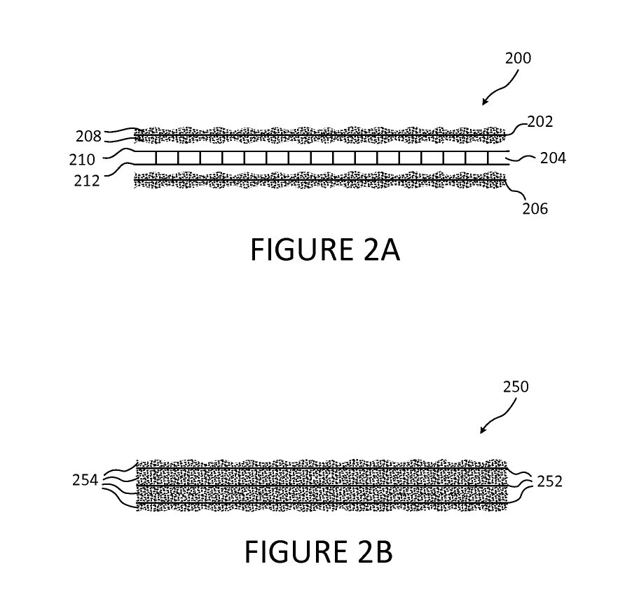

FIGS. 2A and 2B show example structures of reinforced wraps suitable for making caskets shown in FIGS. 1A and 1B. With reference to FIG. 2A, in some embodiments, reinforced wrap 200 includes a spacer layer 204 created from walled cells surrounded by thin reinforcement layers 210 and 212 to form a honeycomb spacer structure. Spacer layer 204 may be further enclosed, on one side or both sides, by one or more thin reinforcement layers 202 and 206 coated or saturated with a layer of resin 208 or other strong bonding medium.

In various embodiments, any of the thin layers 202, 206, 210, and 212 may be a Fiber Reinforced Polymer (FRP) fabric saturated with resin or other bonding material. The FRP fabric may be pre-saturated with resin, which is activated by various methods during the manufacturing of the casket after being deployed onto the forming mold to create the shell of the casket. The resin may be activated to harden by various methods such as by using Ultra Violet (UV) light, exposure to air, exposure to water by spraying water on it, exposure to another chemical, exposure to heat, and the like.

FRP in the fabric form is flexible prior to curing, and thus, is suitable for deploying onto the mold to take on and embed within itself the intricate carvings, designs, and patterns which may have been carved or built into the mold for the purpose of forming the casket shell.

In various embodiments, the FRP provides more resistance against various types of loading, such as static weight and dynamic movements and light impacts. Those skilled in the art will appreciate that many types of reinforcement fibers may be used for reinforcement in FRP including polymer, fiberglass, metal, cotton, other natural fibers, and the like. The sheet materials may include fabrics made with fibers such as glass, carbon, Kevlar, Nomex, aluminum, and the like, some saturated with a polymer such as polyester, vinyl ester, or epoxy for added strength, wear resistance, and resilience. The fibers within a reinforcement sheet/layer may be aligned in one direction, in cross directions, randomly oriented, or in curved sections to provide various mechanical properties, such as tearing tendency and differential tensile strength along different directions, among others. Examples of fabrics used in this application are QuakeWrap® VB26G (Biaxial Glass Fabric), QuakeWrap® TU18C (Uniaxial Carbon Fabric), QuakeBond™ J300SR (Saturating Resin) that cures in ambient temperature and QuakeBond™ 350HC (Heat Cure Resin) that requires heating to temperatures of approximately 250-350 F for curing.

In a lamination arrangement, different reinforcement layers may use sheets with fibers oriented in different directions, such as orthogonal directions, with respect to other sheets to further reinforce the reinforcement wrap and the casket shell. The reinforcement layers may be laminated during manufacturing using epoxy, various glues, or similar adhesives to create a thick laminate that will be stiffer than the sum of the individual reinforcement layers. Reinforcement sheets are available from industrial sources and range in thickness from about 0.020 inches to a few inches depending on application. Those skilled in the art will appreciate that thinner or thicker sheets may be constructed and used as needed.

In various embodiments, one or more of each of the honeycomb layers and reinforcement layers may be used to construct the reinforcement wrap. The layers may be applied in any order on one or both sides. The honeycomb layer may be laminated with at least two skin layers, for example, layers 210 and 212 to form a honeycomb or largely hollow laminate. The honeycomb layer cells may be filled by other reinforcement material such as foam, resin, polymers, epoxy, light weight concrete, or other material to increase the structural stiffness of the honeycomb layer.

Honeycomb layers are generally constructed of adjacent cells, each cell having walls that enclose the cells. Within each of the cells and surrounded by the cell walls, a hollow space is created to reduce the weight of the honeycomb or hollow-structure layer. The cell walls create a relatively thick sheet, the thickness of the sheet being substantially determined by the height of the cell walls, which sheet has substantially greater stiffness compared to a flat sheet of the same sheet material without such cells and cell walls. As an example, if two layers of a carbon fabric each having a thickness of 0.05 inches are bonded together, the resulting sheet will be 0.10 inch thick and it will have certain stiffness. Now, if the same two layers of fabric are bonded to the skin of a 0.3 inch thick honeycomb, the result is a laminate that is 0.4 inch thick. However, this laminate will have a stiffness 37 times that of the previous one. The 0.3 inch thick honeycomb weighs and costs little. This is the one of the advantages of the apparatus disclosed herein that allows the construction a very light-weight but stiff and strong container.

Honeycomb or hollow structure itself is available in various geometrical cell shapes and provides cells that when sandwiched between a first and a second honeycomb skin layers made from thin reinforcement sheets results in a light-weight but stiff laminate sheet. This honeycomb laminate layer structure provides additional strength and stiffness to the reinforcement wrap.

The spacer layer 204 can be of made from many different materials such as foam, 3D fabrics, etc. 3D fabrics are woven in a special way where two separate layers of fabric are connected together having fibers, called pillars, that are typically 0.2-1.0 inch tall. Once the fabric is saturated with resin, these pillars rise to their full length, creating a 3D structure that is as thick as the height of the pillars.

In various embodiments, multiple honeycomb laminates may be employed to further reinforce the reinforcement wrap or casket shell. Various layers in the reinforcement wrap may be glued to each other to form one integral laminate wrap. In some embodiments, each layer in the wrap may be made from a different or same type of reinforcement sheet to develop different costs, performances, and mechanical properties for the reinforcement wrap. For example, the outer layers may be made from thicker and tougher reinforcement sheets while the inner layers (closer to the inside of the casket or container) may be made from thinner and more flexible sheets to save material and installation or construction costs. Other variations in sheet layers are possible, such as fiber types and orientations, sheet materials, sheet material properties like chemical resistance, heat resistance, gas and fluid impermeability, and the like. Reinforcement wraps made with such variations in reinforcement layers will exhibit different mechanical and chemical properties suitable for different applications, costs levels, and considerations such as environmental and public safety considerations.

The multi-layer embodiments may be pre-glued and integrated prior to manufacturing or be integrated during the manufacturing process.

In other various embodiments, some or all of the honeycomb or hollow-structure cells may be filled with one or more of a filler material, such as foam, concrete, polymer, and the like to displace the air within the cells and provide additional strength to the honeycomb or hollow-structure layer. The cell filling material may be injected or otherwise be placed within the cells after attaching the first honeycomb or hollow-structure skin layer, and then be covered and glued in place with the second skin layer. The skin layers themselves may be multi-layered in some embodiments.

In various embodiments, each cell in the honeycomb layer is in the form of a square or rectangle rather than a hexagon or octagon as is typically implied by the term “honeycomb”. Honeycomb structure may be constructed from many different materials similar to those listed and described above with respect to the reinforcement sheets, such as aluminum, PVC, Kevlar, Nomex, and the like.

Those skilled in the art will appreciate that many other honeycomb type layers, hollow structures, or laminate structures are possible without departing from the spirit of the present disclosures. For example, the honeycomb cells may be constructed in any geometric form, such as rectangle, hexagon, and the like to serve the same purpose.

In application, with reference to FIG. 2B, different reinforcement wraps with different layer configurations may be used in the construction of the casket or other container shell. For example, the bottom layer of the casket which bears the most load may be made of reinforcement wrap constructed from one or more of the honeycomb laminates, while the side walls or cap may be made of only a few layers of reinforcement sheets without a honeycomb layer, as shown in FIG. 2B. In this configuration, one or more reinforcement sheets 252 are saturated with resin layers 254 to create a strong but thin reinforcement wrap for the construction of parts or all of the casket shell.

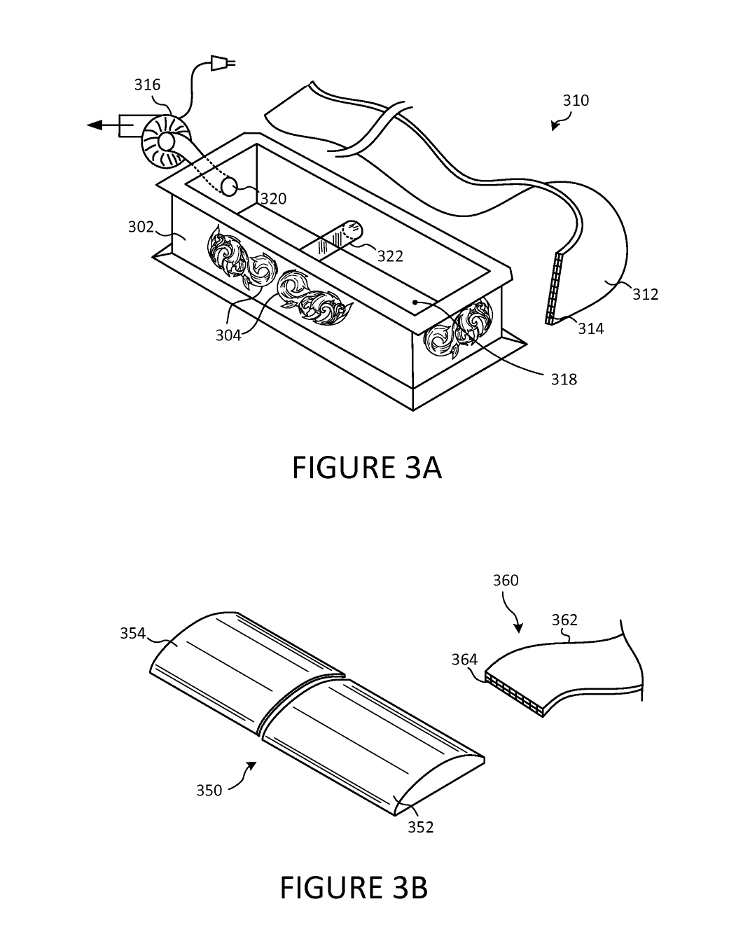

FIG. 3A shows an example arrangement usable to manufacture a casket main body from reinforced wrap. In various embodiments, manufacturing arrangement 310 includes mold 302 having carvings 304, interior space 318, spacer member 322, coupled with air vacuum or blower pump 316 via opening 320. Reinforcement wrap 312 having multiple layers 314 is wrapped around mold 302 to form a shell for the casket.

In some embodiments, small openings or holes are provided throughout the surface area of mold 302 to allow vacuum pump 316 to cause reinforcement wrap 312 to be firmly pressed against the mold, by suction pressure, and take on the shape of the mold. In some embodiments, multiple layers of the reinforcement wrap may be wrapped around the mold, one at a time, while in other embodiments a multilayer reinforcement wrap is wrapped once around the mold. In some embodiments, a different type of molding arrangement may be used such as compression mold, at least for making some portions of the casket shell. In some embodiments, the sidewalls of the mold are removable and held in place only under pressure from spacer member 322. More than one spacer member may be used, depending on the mold's design, to hold the mold in place while the reinforcement wrap is applied.

In some embodiments, the resin in the reinforcement wrap may be applied after the wrap is applied to the mold, while in other embodiments, the wrap is pre-saturated with resin. After the wrap is applied to the mold (for example, by wrapping it around the mold), it may be cured and hardened using Ultra Violet (UV) light, exposure to air, exposure to heat, exposure to water by spraying water on it, exposure to another chemical, and the like. When the resin is hardened, the casket or container shell is substantially formed. The spacer members may be removed to allow the removal of the mold. This process may be repeated as needed with different molds to fabricate each component of the container or casket.

FIG. 3B shows an example arrangement usable to manufacture a casket cover from reinforced wrap. In some embodiments, casket lid 350 includes a lower section 352 and an upper section 354. In some embodiments, reinforced wrap 360 includes a reinforced sheet, such as FRP, and other layers 364 including honeycomb layers. In other embodiment, reinforced wrap does not include honeycomb layers to allow thinner and more flexible sections. The casket cover is substantially manufactured as described above with respect to FIG. 3A.

In some embodiments, the casket shell is manufactured to form a one-piece shell, while in other embodiments, multiple components are constructed and attached to make the casket. A casket or other container or case so manufactured is generally lighter, stronger, faster to produce, and costs less than traditional high quality caskets and containers. As an example, a container or casket can be built in the shape of a hollow tube, such as a cylinder, with only one end open. A removable lid made with similar materials can be used to close the casket. This allows the deceased to be slid into the casket or partially pulled out for viewing. Those skilled in the art will appreciate that the cross section of the tube may be have any shape including circle, oval, square, rectangular, polygonal, or any other suitable shape without departing from the spirit of the present disclosure.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The above specification, examples, and data provide a complete description of the manufacture and use of the composition of the invention. Since many embodiments of the invention can be made without departing from the spirit and scope of the invention, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A container comprising:
a rigid body constructed from a multilayer reinforced wrap including at least one reinforced sheet and one bonding layer; and
a closeable lid.

2. The container of claim 1, further comprising a honeycomb layer as part of the reinforced wrap.

3. The container of claim 1, further comprising carving patterns embedded therein.

4. The container of claim 1, wherein the rigid body comprises a burial casket shell.

5. The container of claim 1, wherein the reinforced sheet comprises a Fiber Reinforced Polymer (FRP) sheet.

6. The container of claim 1, wherein the bonding layer comprises a curable resin layer.

7. The container of claim 1, wherein the rigid body is constructed using a vacuum mold.

8. The container of claim 1, wherein the closeable lid is constructed from the reinforced wrap.

9. The container of claim 1, wherein the closeable lid is constructed as an integral part of the rigid body.

10. A method of constructing a rigid container, the method comprising:
using a forming mold configured to be used to form a rigid body of the rigid container;
wrapping a reinforced wrap, including at least one reinforced sheet and one bonding layer, around the forming mold; and
curing the bonding layer to harden the rigid body.

11. The method of claim 10, further comprising using an air pump to force the reinforced wrap against a surface of the forming mold.

12. The method of claim 10, further comprising using a separate forming mold to form a lid configured to be integrated with the rigid body.

13. The method of claim 10, wherein the forming mold is a vacuum mold.

14. The method of claim 10, wherein the forming mold includes carvings configured to be embedded in the rigid body.

15. The method of claim 10, wherein the forming mold includes handle cavities configured to be embedded in the rigid body.

16. The method of claim 10, wherein the reinforced sheet comprises a Fiber Reinforced Polymer (FRP) sheet.

17. The method of claim 10, wherein the rigid body includes an integral lid.

18. The method of claim 10, wherein the bonding layer comprises a curable resin.

19. The method of claim 10, wherein the curing the bonding layer comprises using heat or Ultra Violet (UV) light to cure the bonding layer.

20. The method of claim 10, wherein the reinforced sheet comprises a honeycomb layer.
